(19) United States
(12) Patent Application Publication
(10) Pub. No.: US 2017/0061341 A1
(43) Pub. Date: Mar. 2, 2017

(54) WORKFLOW MANAGEMENT FOR CROWD WORKER TASKS WITH FIXED THROUGHPUT AND BUDGETS

(71) Applicant: Go Daddy Operating Company, LLC, Scottsdale, AZ (US)

(72) Inventors: Daniel Haas, Madison, WI (US); Jason Ansel, Seattle, WA (US); Zhenya Gu, New York, NY (US); Adam Marcus, Cambridge, MA (US)

(21) Appl. No.: 15/253,411

(22) Filed: Aug. 31, 2016

Related U.S. Application Data
(60) Provisional application No. 62/212,989, filed on Sep. 1, 2015.

(51) Int. Cl. G06Q 10/06; G06F 17/30; G06F 3/0482

(52) U.S. Cl. CPC G06Q 10/0633; G06F 3/0482; G06F 17/3053; G06F 17/30598; G06Q 10/06393

(57) ABSTRACT

Systems and methods of the present invention provide for one or more server computers configured to assign section or list item classifications to price list or business data extracted from a website. The server assigns section or list item classifications to price list or business data extracted from a website. The server calculates a crowd worker score for each of a plurality of crowd workers based on each worker's quality and speed scores for tasks reviewing the classifications on a worker user interface. If a crowd worker score for a worker is below a crowd worker quality threshold, each new task is routed to the worker, and the received task, when completed, is routed to a worker whose crowd worker score is above the crowd worker quality threshold for review. The server then identifies a budget for the tasks, and repeats the process for subsequent tasks, transmitting reviewed tasks to a second level task reviewer according to a threshold number of reviewed tasks for second level review, based on the budget.

### CROSS-REFERENCE TO RELATED APPLICATION

This application claims priority to provisional application No. 62/212,989 filed on Sep. 1, 2015.

### STATEMENT OF FEDERALLY SPONSORED RESEARCH OR DEVELOPMENT

Not applicable.

### FIELD OF THE INVENTION

The present invention generally relates to the field of crowd sourcing and specifically to identifying specific workers who will provide a most efficient review of crowd sourced materials.

### SUMMARY OF THE INVENTION

The disclosed invention considers context-heavy data processing tasks that may require many hours of work, and refer to such tasks as macrotasks. Leveraging the infrastructure and worker pools of existing crowd sourcing platforms, the disclosed invention automates macrotask scheduling, evaluation, and pay scales. A key challenge in macrotask-powered work, however, is evaluating the quality of a worker's output, since ground truth is seldom available and redundancy-based quality control schemes are impractical. The disclosed invention, therefore, includes a framework that improves macrotask powered work quality using a hierarchical review. This framework uses a predictive model of worker quality to select trusted workers to perform review, and a separate predictive model of task quality to decide which tasks to review. Finally, the disclosed invention can identify the ideal trade-off between a single phase of review and multiple phases of review given a constrained review budget in order to maximize overall output quality.

In some embodiments a server assigns section or list item classifications to price list or business data extracted from a website. The server calculates a crowd worker score for each of a plurality of crowd workers based on each worker's quality and speed scores for tasks reviewing the classifications on a worker user interface. If a crowd worker score for a worker is below a crowd worker quality threshold, each new task is routed to the worker, and the received task, when completed, is routed to a worker whose crowd worker score is above the crowd worker quality threshold for review.

In some embodiments a server assigns section or list item classifications to price list or business data extracted from a website. Each new task verifying the classification is routed to a crowd worker, and a completed task is received by the server. The server then calculates a crowd worker score for each of a plurality of crowd workers based on each worker's quality scores according to the worker's review of the classifications on a worker user interface. The server then generates a quality model for predicting a task quality score for the task, according to an error score for the crowd worker. If the error score in the quality model is below a predetermined threshold, the server automatically transmits the completed task to a client computer operated by at least one task reviewer for review.

In some embodiments a server assigns section or list item classifications to price list or business data extracted from a website. The server calculates a crowd worker score for each of a plurality of crowd workers based on each worker's quality and speed scores for tasks reviewing the classifications on a worker user interface. If a crowd worker score for a worker is below a crowd worker quality threshold, each new task is routed to the worker, and the received task, when completed, is routed to a worker whose crowd worker score is above the crowd worker quality threshold for review. The server then identifies a budget for the tasks, and repeats the process for subsequent tasks, transmitting reviewed tasks to a second level task reviewer according to a threshold number of reviewed tasks for second level review, based on the budget.

The above features and advantages of the present invention will be better understood from the following detailed description taken in conjunction with the accompanying drawings.

### BRIEF DESCRIPTION OF THE DRAWINGS

FIG. 1 illustrates tradeoffs in human-powered task completion models.

FIG. 2 illustrates the current invention's framework architecture for macrotask data processing.

FIG. 3 illustrates a crowd- and machine learning-powered workflow for extracting structured price list data.

FIG. 4 illustrates the current invention's framework crowd worker user interface on a price list extraction task.

FIG. 5 illustrates the hierarchy of task review. Trusted workers review entry-level workers' output and provide low-level feedback on tasks, managers provide high-level feedback to every worker, and a model of worker speed and accuracy chooses workers to promote and demote throughout the hierarchy.

FIG. 6 illustrates the distribution of processing times for price list tasks, broken down by the initial task, the first review, and the second review. Times are at 30-second granularity. Lines within boxes represent the median. Box represents the 25 to 75th percentiles. Whiskers represent 5 and 95th percentiles.

FIG. 7 illustrates cumulative percentage of each task changed divided by total number of tasks for TaskGrader models trained on various subsets of features, with random review provided as a baseline. This figure contains Review 1 findings only, with Review 2 performance excluded. Descriptions of which features fall into the Task Specific, Worker Specific, Domain Specific, and Generalizable categories can be found in Table 1.

FIG. 8 illustrates cumulative percentage of each task changed divided by total number of tasks for TaskGrader in both phase one and phase two of review.

FIG. 9 illustrates cumulative percentage of each task changed divided by total number of tasks for different budgets of total reviews. The left side represents spending 100% of the budget on phase one, the right side represents splitting the budget 50/50 and reviewing half as many tasks two times each.

FIG. 10 illustrates a flow chart for a hierarchical review structure for crowd worker tasks.

FIG. 11 illustrates a flow chart for a predictive model of task quality for crowd worker tasks.

FIG. 12 illustrates a flow chart for workflow management for crowd worker tasks with fixed throughput and budgets.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Systems that coordinate human workers to process data make an important trade-off between complexity and scale. As work becomes increasingly complex, it requires more training and coordination of workers. As the amount of work (and therefore the number of workers) scales, the overheads associated with that coordination increase. Worker organization models for task completion have significant implications for the complexity and scale of the work that can be accomplished with those models. Crowd sourcing has recently been used to improve the state of the art in areas of data processing such as entity resolution, structured data extraction, and data cleaning. Human computation is commonly used for both processing raw data and verifying the output of automated algorithms.

Crowd sourced workflows are used in research and industry to solve a variety of tasks. An important concern when assigning work to crowd workers with varying levels of ability and experience is maintaining high-quality work output. Thus, a prominent focus of the crowd sourcing literature has been on quality control: developing workflows and algorithms to reduce errors introduced by workers either unintentionally (due to innocent mistakes) or maliciously (due to collusion or spamming). Three organizational models are compared below: microtask-based decomposition, macrotasks, and traditional freelancer-based knowledge work. Several examples of problems solved at scale with macrotasks are provided.

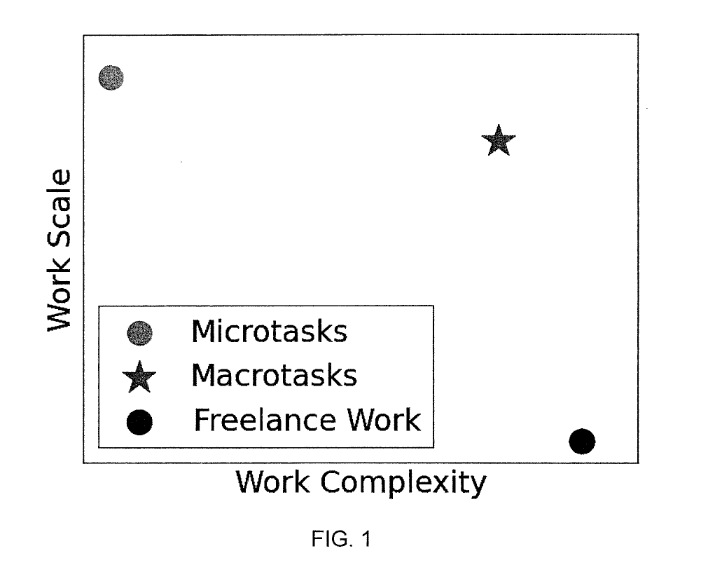

FIG. 1 compares three forms of worker organization by their ability to handle scale and complexity. Typically, microtasks are used with voting algorithms to combine redundant responses from multiple crowd workers to achieve result quality. For example, a common microtask is image annotation, where crowd workers help label an object in an image. As more and more workers agree on an annotation, the confidence of that annotation increases. Microtasks, such as image labeling tasks sent to Amazon Mechanical Turk, are easy to scale and automate, but require effort to decompose the original high-level task into smaller microtask specifications, and are thus limited in the complexity of work they support. The databases community has used crowd workers in query operators/optimization and for tasks such as entity resolution.

Most research on quality control in crowd sourced workflows has focused on platforms that define work as microtasks, where workers are asked simple questions that require little context or training to answer. Microtasks are an attractive unit of work, as their small size and low cost make them amenable to quality control by assigning a task to multiple workers and using worker agreement or voting algorithms to surface the correct answer. Microtask research has focused on different ways of controlling this voting process while identifying the reliability of workers through their participation. Such research utilizes microtasks where crowd workers are asked to answer simple yes/no or multiple choice questions with little training.

Unfortunately, not all types of work can be effectively decomposed into microtasks. Microtasks are powerful, but fail in cases where larger context (e.g., domain knowledge) or significant time investment is needed to solve a problem, for example in large-document structured data extraction. Tasks that require global context (e.g., creating papers or presentations) are challenging to programmatically sub-divide into small units. Additionally, voting strategies as a method of quality control break down when applied to tasks with complex outputs, because it is unclear how to perform semantic comparisons between larger and more free-form results.

Thus, an alternative to seeking out good workers on microtask platforms and decomposing their assignments into microtasks is to recruit crowd workers to perform larger and more broadly defined tasks over a longer time horizon. Such a model allows for in-depth training, arbitrarily long-running tasks, and flexible compensation schemes. There has been little work investigating quality control in this setting, as the length, difficulty, and type of work can be highly variable, and defining metrics for quality can be challenging. Traditional freelancer-based knowledge work supports arbitrarily complex tasks, because employers can interact with workers in person to convey intricate requirements and evaluate worker output. This type of work usually involves an employer personally hiring individual contractors to do a fairly large task, such as designing a website or creating a marketing campaign. The work is constrained by hiring throughput and is not amenable to automated quality control techniques, limiting its ability to scale.

Another alternative includes macrotasks. Macrotasks represent a trade off between microtasks and freelance knowledge work, in that they provide the automation and scale of microtasks, while enabling much of the complexity of traditional knowledge work. In this disclosure, the term macrotask is used to refer to such complex work. This disclosure discusses both the limitations and the opportunities provided by macrotask processing, and then presents a framework that extends existing data processing systems with the ability to use high-quality crowd sourced macrotasks. The disclosed embodiments present the output of automated data processing techniques as the input to macrotasks and instructs crowd workers to eliminate errors. As a result, it easily extends existing automated systems with human workers without requiring the design of custom-decomposed microtasks. Macrotasks, a middle ground between microtasks and freelance work, allow complex work to be processed at scale. Unlike microtasks, macrotasks don't require complex work to be broken down into simpler subtasks: one can assign work to workers essentially as-is, and focus on providing them with user interfaces that make them more effective. Unlike traditional knowledge work, macrotasks retain enough common structure to be specified automatically, processed uniformly in parallel, and improved in quality using automated evaluation of tasks and workers. Much of the complex, large-scale data processing that incorporates human input is amenable to macrotask processing.

The following three non-limiting example, and high-level data-heavy use-cases, addressed with crowd-powered macrotask workflows at a scale of millions of tasks, demonstrate the utility of macrotasks: 1. Structured Price List Extraction. From Yoga studio service lists to restaurant menus, structured data from PDFs, HTML, Word documents, Flash animations, and images may be extracted on millions of small business websites. When possible, this content is automatically extracted, but if automated extraction fails, workers must learn a complex schema and spend upwards of an hour processing the price list data for a business. 2. Business Listings Extraction. ˜30 facts about businesses (e.g., name, phone number, wheelchair accessibility, etc.) are extracted in one macrotask per business. This task could be accomplished using either microtasks or macrotasks, and it is used to help demonstrate the versatility of the disclosed embodiments. 3. Web Design Choices. Crowd workers are asked to identify design elements such as color palettes, business logos, and other visual aspects of a website in order to enable brand-preserving transformations of website templates. These tasks are subjective and don't always have a correct answer: several color palettes might be appropriate for an organization's branding. This makes it especially challenging to judge the quality of a processed task.

The tasks above, with their complex domain-specific semantics, can be difficult to represent as microtasks, but are well-defined enough to benefit from significant automation at scale. Of course, macrotasks come with their own set of challenges, and are less predominant when compared to microtasks. There exist fewer tools for completing unstructured work, and crowd work platforms seldom offer best practices for improving the quality or efficiency of complex work. Tasks can be highly heterogeneous in their structure and output format, which makes the combination of multiple worker responses difficult and automated voting schemes for quality control nearly impossible. Macrotasks also complicate the design of worker pay structures, because payments must vary with task complexity.

To address the issues above, the disclosed embodiments leverage several cost-aware techniques for improving the quality of worker output. These techniques are domain-independent, in that they can be used for any data processing task and crowd work platform that collects and maintains basic data on individual workers and their work history. First, the disclosed embodiments organize the crowd hierarchically to enable trusted workers to review, correct, and improve the output of less experienced workers. Second, the disclosed embodiments provide a predictive model of task error, referred to herein as a TaskGrader, to effectively allocate trusted reviewers to the tasks that need the most correction. Third, the disclosed embodiments track worker quality over time in order to promote the most qualified workers to the top of the hierarchy. Finally, given a fixed review budget, the disclosed embodiments decide whether to allocate reviewer attention to an initial review phase of a task or to a secondary review of previously reviewed tasks in order to maximize overall output quality. Experiments show that generalizable features are more predictive of errors than domain specific ones, suggesting that the disclosed embodiments' models can be implemented in other settings with little task type specific instrumentation; The disclosure provides a non-limiting example evaluation of these techniques on a production structured data extraction system used in industry at scale. For review budget-constrained workflows, this example shows up to 118% improvement over random spot checks when combining TaskGrader with a two-layer review hierarchy, with greater benefits at more constrained budgets.

Put another way, the disclosed embodiments include the following: 1. A framework for managing macrotask-based workflows and improving their output quality given a fixed budget and fixed throughput requirement; 2. A hierarchical review structure that allows expert workers to catch errors and provide feedback to entry-level workers on complex tasks. The disclosed embodiments model workers and promote the ones that efficiently produce the highest-quality work to reviewer status. The examples herein show that 71.8% of tasks with changes from reviewers are improved; 3. A predictive model of task quality that selects tasks likely to have more error for review. 4. Empirical non-limiting example results that show that under a constrained budget where not every task can be reviewed multiple times, there exists an optimal trade-off between one-level and two-level review that catches up to 118% more errors than random spot checks.

The described embodiments may include one or more computing machines (including one or more server computers and one or more client computers), and one or more databases communicatively coupled through a network. The server and client may include at least one processor executing instructions within a communicatively coupled memory, the instructions causing the computing machines to execute the method steps disclosed herein. The server may store, within a database coupled to the network, a plurality of data, possibly organized into data records and data tables.

A task requester may access a task framework user interface (UI) on a client computer, in order to create a request (“framework?”) for multiple macrotasks (e.g., tasks for identifying and classifying, within website content, menu sections, menu items, prices, and specific context sensitive items, such as adding chicken $4, shrimp $7, or salmon $8 to salad). The requester may input multiple parameters defining the task framework including, for example: a budget and/or throughput requirement; multiple URIs or electronic documents containing task-related content to be crawled in association with the task framework; customized parameters within an API defining a generic schema including grammars used to identify context clues (e.g., HTML tags/attributes, XML tags/attributes, fonts, color schemes, style sheets, etc.) and classify groupings of content (e.g., menu item, menu price, menu section, etc.) within a web page at the URI or within the electronic documents as received, according to the schema; and customized definitions for UI controls, to be accessed by crowd workers in order to verify that classifications assigned to the task content are correct. The user then submits all task framework data to one or more servers, which receives the data and stores it within the database.

In response to receiving the task framework data, the server automatically executes a crawl of the content for each of the designated URIs or other electronic documents, classifies the content according to the context clues defined within the content schema, and stores the content classifications (representing the server's best guess of the content classification) as data records in the database, in association with the task framework, and possibly the crawled URI. The server then renders and transmits, for display on a crowd worker client machine, a UI display allowing crowd workers to verify and/or correct the classifications of the crawled content. In some embodiments, the UI display may include a rendering of the content within a browser as displayed in the web page at the URI or within the electronic document. The UI display may also include an editable display of the data records representing the content as automatically classified by the server.

More experienced crowd workers may train new (or less experienced) crowd workers in analyzing the server's classification for each task (i.e., each URI or electronic document displayed in the crowd worker UI) to determine if the server's automatic classification for the content is correct. The crowd worker being trained may compare the content within the content displayed in the browser, and correct any necessary content classifications by inputting the corrections within the editable display. The crowd worker may submit the task when complete. After decoding the transmission of the submitted task, the server may determine the total amount of content modified by the new crowd worker (e.g., number of lines changed, or percent of content changed compared to the total content). The server may then store the amount of content modified, in association with the designated task, within the database. The server may also determine the task speed (e.g., the time it took the worker to complete the task, possibly the amount of time between the crowd worker receiving the task and submitting it to the server) and stores this data, association with the task, in the database.

Initially, the more experienced crowd worker, or other reviewer, may review each task submitted by the new or less experienced crowd worker, and may identify and correct any errors in the submitted task (possibly using a crowd worker UI designed to review tasks). The reviewer may then submit the review, and the server again determines the amount/percentage of content modified (between the original or previous submission and the review), as well as the task speed for the review, and stores the percentage of modified content and task speed in the database in association with the task. This review process may be repeated as many times as necessary to bring the tasks quality rate above a threshold determined by the task framework budget.

As tasks are completed by each crowd worker, the server may calculate a score for the crowd worker for which the tasks were submitted, based on the quality and the speed with which the crowd worker completed the task. The quality of the task may be calculated as the inverse of the percentage of content modified in reviews of the task. Thus, if a task was reviewed, and 5% of the content was modified by the reviewer (presumably because it was incorrect), the crowd worker would have a 95% quality score for that task (possibly calculated as a decimal, 0.95). The server may analyze the quality scores for all of the crowd worker's tasks at a 75th percentile error rate (associated in the database with the task framework) to calculate an overall quality score for that crowd worker for that request.

This quality scoring process may be repeated for all crowd workers associated in the database with the request, and in some embodiments, the range of quality scores may be normalized, so that the highest quality score is a 1, and the lowest quality score is a 0. The server may then re-calculate each crowd worker's quality score relative to these normalized scores.

Similarly, the server's calculation of the speed element of each crowd worker's score may be a function of selecting the task speed data for all tasks associated with the task framework, and normalizing the highest task speed to 1, and the lowest task speed to 0. The server may then calculate each crowd worker's score relative to these normalized scores, possibly as a decimal representation of the average task speed for that crowd worker, as a percentage of the normalized fastest or slowest score.

The server may then calculate each crowd worker's total quality score as a weighted average between the crowd worker's task quality score and task speed score. Each crowd worker's score may be re-calculated relative to all crowd workers' scores associated with that request each time a submitted task associated in the database with that crowd worker is reviewed.

The server may organize all crowd workers trained for tasks within a specific task framework into a hierarchy of crowd workers by generating a total score for the crowd workers, and ranking them according to their total score. The server may then select the data record defining the budget and any throughput requirements for the task framework and calculate the number tasks, the percentage of completed tasks to review, and the percentage of completed tasks needing a second or subsequent review according to the budget and throughput requirements.

According to these calculations, the server may determine a percentage of the crowd workers for the specific task framework to be designated as data entry specialists (DES), first level reviewers, and second level reviewers needed, and may organize this hierarchy according to the crowd worker rank determined above. As additional tasks are reviewed, and the server re-calculates the scores and ranks for the most recently reviewed tasks, the server may dynamically update the hierarchy to re-designate crowd workers to new levels within the hierarchy, according to the budget and throughput requirements.

For each new completed task submitted by DES workers within the hierarchy, the server may identify the crowd worker identifier associated with the completed task, and identify that crowd worker's quality score (i.e., the normalized inverse of the average percentage of content corrected in that worker's most recent reviewed tasks, at the 70th percentile error rate). Based on this quality score, the server may calculate a predictive error rate/quality score for the most recently received completed task. The server may then compare this score with a threshold error rate, determined by the budget and/or throughput parameters, and if the quality score is below this threshold, the completed task may be flagged for review. All tasks flagged for review may be automatically forwarded by the server to a reviewer for review. This process may be repeated for subsequent levels of review until the predicted quality score no longer falls below the threshold.

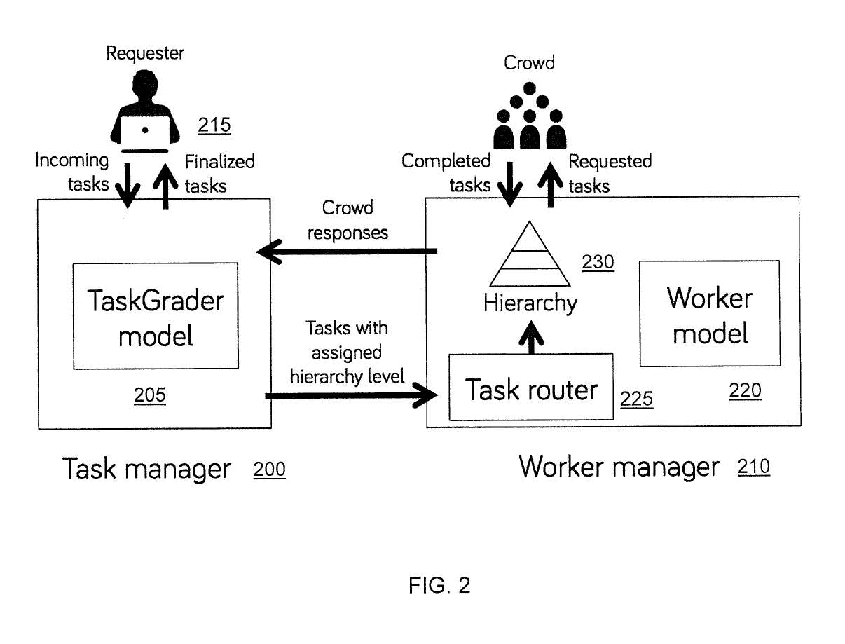

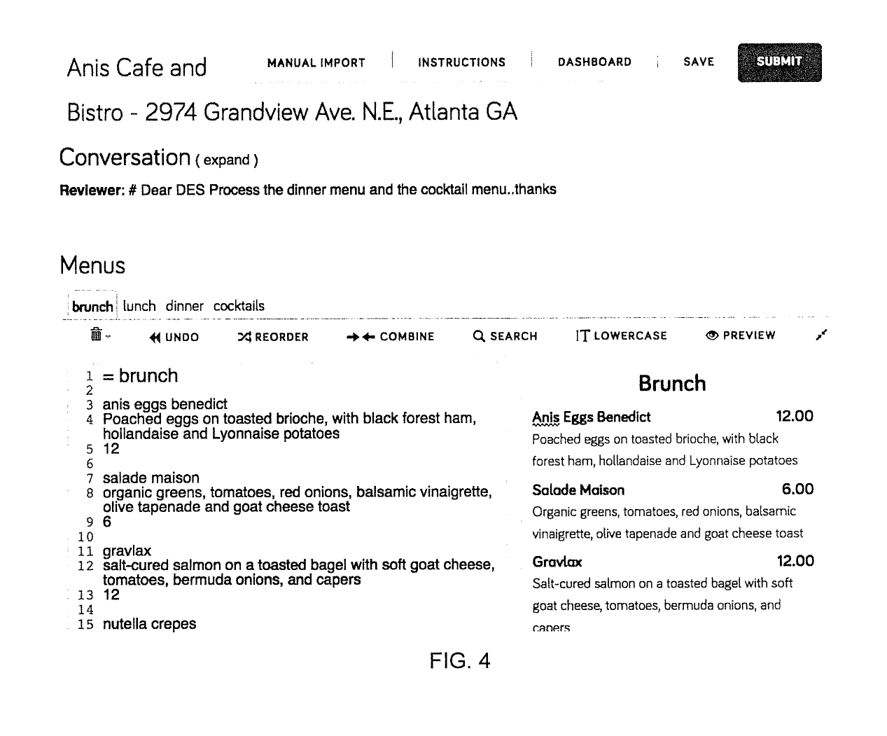

Turning now to FIG. 2, the disclosed embodiments' main components are described by following the path of a task through the framework as depicted. First, a requester submits tasks to the system. The requester specifies tasks within a task framework (possibly including the schema for the automated data extraction, a budget, a fixed throughput, the content to be crawled, etc.) and the UI components to be rendered by the server computer and displayed on the client as the workers' user interface, shown in FIG. 4, using the framework API described above. Newly submitted tasks go to the Task Manager software module 200, which can send tasks to the crowd for processing. The Task Manager software module 200 receives tasks that have been completed by crowd workers, and any combination of the Task Manager software module 200 and the Task Grader software module 205, decides if those tasks should go back to the crowd for subsequent review, or be returned to the requester as a finalized task. The Task Manager software module 200 uses the TaskGrader model 205, which predicts the amount of error remaining in a task, as described below, to make this decision. If the model predicts that a high amount of error remains in the task, the task will require an additional review from the crowd. When a task is sent to the crowd, the Task Manager 205 specifies which expertise level in the review hierarchy 230 should process the task. Tasks that are newly submitted by a requester are assigned to the lowest level in the hierarchy 230, to be processed by workers known as Data Entry Specialists. From the Task Manager 205, tasks go to the Worker Manager 210. The Worker Manager 210 manages the crowd workers and determines which worker within the assigned hierarchy level 230 to route a task to.

The described embodiments may include one or more computing machines (including one or more server computers and one or more client computers 115) and one or more databases communicatively coupled through a network. The server and client 115 may include at least one processor executing instructions within a communicatively coupled memory, the instructions causing the computing machines to execute the method steps disclosed herein. The server may store, within a database, a plurality of data, possibly organized into data records and data tables.

As non-limiting examples, the processor on the server may execute the instructions including, as non-limiting examples, one or more software modules, such as one or more task manager software modules 100, one or more task grader software modules 105, one or more worker manager software modules 110, one or more worker model software modules 120, and/or one or more task router software modules 125. The data received from the client computer 115 and/or from calculations run by the disclosed software modules may be stored by the server in the database and decoded and executed by the processor within memory according to the software instructions within the disclosed software modules to complete the method steps disclosed herein.

This section provides an overview of a task framework that combines automated models with complex crowd tasks. This task framework is a scheme for quality control in macrotasks that can generalize across many applications in the presence of heterogeneities task outputs. This task framework may be used for performing several data processing tasks, but will use structured data extraction as a running example. To reduce error introduced by crowd workers while remaining domain-independent, the task framework uses three complementary techniques that are described next: a review hierarchy, predictive task modeling, and worker modeling. These techniques are effective when dealing with tasks that are complex and highly context-sensitive, but still have structured output.

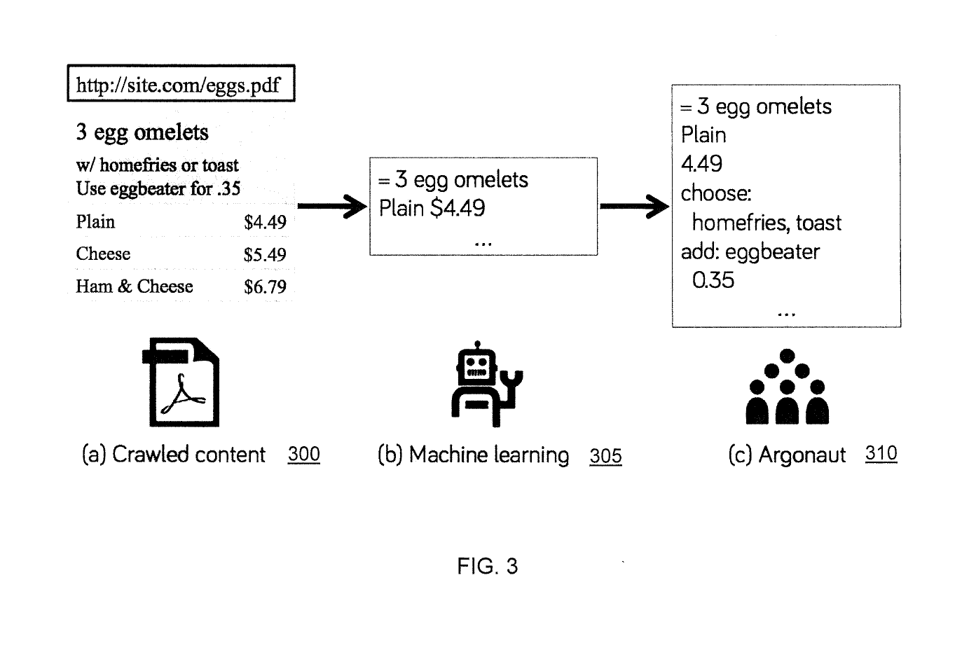

Turning now to FIGS. 2-3, the previous discussion gave a flavor of the work accomplished using macrotask crowd sourcing. A non-limiting structured price list extraction use case will now be described in depth to demonstrate how macrotasks flow between crowd workers, and how the crowd fits in with automated data processing components. This structured data extraction task will be used as a running example throughout the paper. For simplicity, this example will focus on extraction of restaurant menus, but the same workflow applies for all price lists.

A task requester may create a task framework defining the details of the tasks to be distributed among the hierarchy of crowd workers. The task requester may access a task framework UI, displayed on a client computer 115, in order to define the task framework for the tasks that the task requester is requesting. This task framework may define: multiple macrotasks the requester wants performed; a classification schema defining parameters that the server computer uses to automatically extract and assign classifications to the content; identify designated documents (e.g., crawled web pages, uploaded price lists), to which the classification schema and extractors apply; and/or definitions of UI elements to be displayed to crowd workers as they determine if the classifications assigned to the content by the automatic extractors are correct.

The task requester may also input budget and/or fixed throughput information in association with the requested task framework. The server may store, within the database, task framework data input by the requester or other user. In some embodiments, each task framework data may be stored within its own data record, in a data table storing task framework information, such as the example data table below.

| id | name | tasks | budget |
|---|---|---|---|
| 1 | Menu price list | 1000 | $25,000 |
| 2 | Business listings | 1500 | $30,000 |
| . . . | . . . | . . . | . . . |

Each data record in this example data table may include: a task framework id data field storing a unique id associated with task framework; a task framework name data field naming or describing the task framework; a data field storing the number of tasks to be completed; and a budget data field storing the budget for the requested task framework.

In the example data table above, the server may receive the task framework data, and automatically generate and store the data record with a task framework id 1, with a task framework name “Menu Classification,” a number of tasks set at 1000, and a budget of $25,000. This example task framework data table also includes an additional data record subsequently received by the server. Though beyond the scope of the disclosed embodiments, additional data tables and data records may also store task framework details relating to the content extraction and classification schemas and crowd worker UI controls, described below.

The task requester may access, possibly via the task framework UI, an API defining a generic task framework for macrotasks that the task requester may want to request. In the case of the non-limiting price list extraction task example, the generic framework may include a content schema and a collection of generic parameters including machine learned classifiers stored within the database and used to identify potential menu sections, menu item names, prices, descriptions, and item choices and additions (e.g., identifying and classifying, within a restaurant website content, menu sections, menu items, prices, and specific context sensitive items, such as adding chicken $4, shrimp $7, or salmon $8 to salad).

These machine-learned classifiers may define the parameters which the server computer uses to execute software that acts as automated extractors (explained in more detail below), in order to analyze, classify and extract content while crawling designated websites or receiving uploaded price lists, for example. These parameters may include generic parameters for grammars within the schema used to define context clues (e.g., HTML tags/attributes, XML tags/attributes, fonts, color schemes, cascading style sheets, etc.) used to identify and/or classify content within a web page, website, and/or received price list (e.g., menu item, menu price, menu section, etc.).

The requester, using the framework UI, may further customize the content schema for the generic task framework according to user-specific input modifying or adding to the parameters of the generic framework. These additional parameters may include one or more new macrotask types. To define a new macrotask type, a developer using the disclosed embodiments provide task data. Users must implement a method that provides task-specific data encoded as JSON for each task. Such data might be serialized in various ways. For example, business listings tasks produce a key-value mapping of business attributes (e.g., phone numbers, addresses). For price lists, a markup language allows workers to edit blocks of text and label them (e.g., sections, menu items).

The requestor may also provide the technical parameters for a method within one or more worker interface renderer software modules running on the server. The technical parameters for these methods may include customized definitions for the UI controls for the worker interface, used by the worker to verify that the extractors' classifications of the website content or uploaded price lists are correct. Users adding a new macrotask type to the disclosed framework need not write any backend code to manage tasks or workers. They simply build the user interface for the task workflow and wire it up to the framework's API. FIG. 4 shows the disclosed framework as experienced by a crowd worker on a price list extraction task. The Menu section is designed by the user/developer of the framework. The rest of the interface is uniform across all task types, including a Conversation box for discussion between crowd workers. Given task data, users must implement a method that generates an HTML <div> element with a worker user interface. Here is an example rendering of menu data:

```
def get_render_html( ):
  return “““
  <div>
```

<p>Edit the text according to the
<a href=“guidelines.html”>guidelines.</a>
Please structure
<a href =“{{menu_url}}”>this menu.</a></p>
<form><textarea name=“structured menu”
value=“{{data.menu_text}}”></form>

</div>”””

Other interface features (e.g., a commenting interface for workers to converse, buttons to accept/reject a task) are common across different task types and provided by the disclosed embodiments.

The requester may also provide one or more error metrics. Given two versions of task data (e.g., an initial and a reviewed version), an error metric helps the TaskGrader, described below, determine how much that task has changed. For textual data, this metric might be based on the number of lines changed, whereas more complex metrics are required for media such as images or video. Users can pick from the disclosed embodiments' pre-implemented error metrics or provide one of their own.

The task requester may also designate a collection of one or more URIs or data sources identifying the web pages/websites to be crawled, and/or one or more data sources for the uploaded or received price lists, in association with the tasks to be completed for the requested task framework. The user then submits the task framework/request data to one or more servers, which receives the data and stores it within the database.

In response to receiving the task request data, the server may automatically executes a crawl of the content for each of the designated URIs, and/or analyze the price list data uploaded from the designated data source(s). FIG. 3 shows the data extraction process. The disclosed embodiments crawl small business websites or accept price list uploads from business owners as source content 300 from which to extract price lists. Price lists come in a variety of formats, including PDFs, images, flash animations, and HTML.

The server may run the software modules implementing the automated extractors, in order to classify the content of each URI and/or uploaded price list making up a task, according to the machine learned classifiers, using the context clues defined within the content schema. For example, automated extractors (e.g., optical character recognition, flash decompilation), and machine learned classifiers 305 may identify potential menu sections, menu item names, prices, descriptions, and item choices and additions. Using the automated extractor software 305, the server may store the content classifications (representing the server's best guess of the content classification) as data records in the database, in association with the crawled URI or price list identifying the task framework.

The server may store, within the database, extracted task data generated as the server runs the content extractor software modules. In some embodiments, each extracted task data may be stored within its own data record, in a data table storing extracted task information, such as the example data table below.

| id | f-id | m-id | item | description | price |
|---|---|---|---|---|---|
| 1 | 1 | 1 | anis eggs benedict | Poached eggs on | 12 |
| | | | | toasted brioche, with | |
| | | | | black forest ham, | |
| | | | | hollandaise and | |
| | | | | Lyonnaise potatoes | |
| 2 | 1 | 1 | salade maison | organic greens, | 6 |
| | | | | tomatoes, red onions, | |
| | | | | balsamic vinaigrette, | |
| | | | | olive tapenade and goat | |
| | | | | cheese toast | |
| . . . | | . . . | . . . | . . . | . . . |

Each data record in this example data table may include: an extracted task id data field storing a unique id associated with the extracted task; a task framework id data field associating the extracted task with a task framework; a menu id data field associating the extracted task with a menu (e.g., “Brunch”, not shown), an extracted item data field naming the extracted menu item; a description data field describing the extracted menu item; and a price data field storing a price for the extracted menu item.

In the example data table above, the server may run the content extractor software, and automatically generate and store the data record with a extracted task id 1, a task framework id of 1, a menu id of 1 (“Brunch”), an item name of anis eggs benedict, a description of Poached eggs on toasted brioche, with black forest ham, hollandaise and Lyonnaise potatoes, and a price of $12. This example task framework data table also includes an additional data record subsequently received by the server.

The resulting crowd-structured data is used to periodically retrain classifiers to improve their accuracy. The macrotask model provides for lower latency and more flexibility in throughput when compared to a freelancer model. One requirement for the use of these price list extraction tasks is the ability to handle bursts and lulls in demand. Additionally, for some tasks, very short processing times may be required. These constraints make a freelancer model, with slower on-boarding practices, less well suited to this example problem than macrotasks.

Microtasks are also a bad fit for this price list extraction task. The tasks are complex, as workers must learn the markup format and hierarchical data schema to complete tasks, often taking 1-2 weeks to reach proficiency. Using a microtask model to complete the work would require decomposing it into pieces at a finer granularity than an individual menu. Unfortunately, the task is not easily decomposed into microtasks because of the hierarchical data schema: for example, menus contain sections which contain subsections and/or items, and prices are frequently specified not only for items, but for entire subsections or sections. There would be a high worker coordination cost if such nested information were divided across several microtasks. In addition, because raw menu text appears in a number of unstructured formats, deciding how to segment the text into items or sections for microtask decomposition would be a challenging problem in its own right, requiring machine learning or additional crowdsourcing steps. Even if microtask decomposition were successful, traditional voting-based quality control schemes would present challenges, as the free-form text in the output format can vary (e.g. punctuation, capitalization, missing/additional articles) and the schema requirements are loose. Most importantly, while it might be possible in some situations to generate hundreds of microtasks for each of the hundreds of menu items in a menu, empirical estimates based on business process data suggests that the fair cost of a single worker on the complex version of these tasks is significantly lower than the redundant version of the many microtasks it would take to process most menus.

In the following sections, the system designed for implementing the price lists task and other macrotask workflows will be described, focusing specifically on the challenges of improving work quality in complex tasks.

Turning now to FIG. 4, the server renders and transmits, for display on a crowd worker client machine, a UI display allowing crowd workers to verify correct classification of the crawled content. To accomplish this, the server may select a data record(s) from the database, as seen above, representing the output of the classification accomplished by running the automated extractor software on the designated URI or uploaded price list.

As seen in FIG. 4, the output of these classifications is displayed to crowd workers 310 in a text-based wiki markup-like format that allows fast editing of menu structure and content, according to the task data provided by the content extractors, implementing a method that generates an HTML <div> element with a worker user interface. Thus, the UI display rendered by the server may include an editable display of the data records representing the content as collected from the automated extractors and automatically identified, classified and stored by the server. In embodiments such as that seen in FIG. 4, the UI display may include a rendering of the content within a browser analogous to that displayed in the web page or website at the URI's.

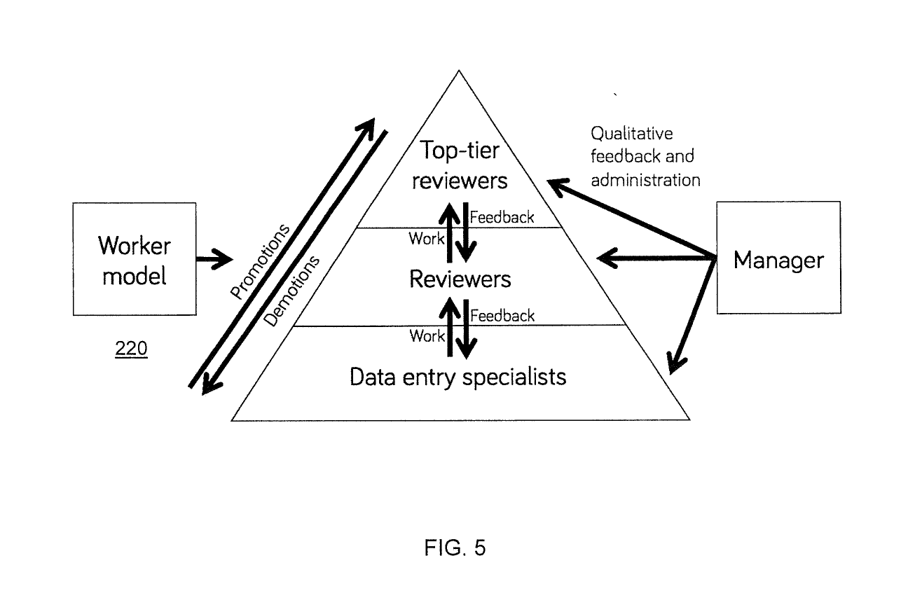

Turning now to FIG. 5, developing a trusted crowd requires significant investment in on-boarding and training. More experienced crowd workers may train new (or less experienced) crowd workers in analyzing the content extractors' classification for each task (i.e., the content of each URI displayed in the crowd worker UI) to determine if the content extractors' automatic classification for the content is correct. For example, on-boarding a DES may require that they spend several days studying a text- and example-heavy guide on the price list syntax defined in the task structure. The worker must pass a qualification quiz before she or he can complete tasks. A newly hired worker may have a trial period of 4 weeks, during which every task they complete is reviewed. Because the training examples can not cover all real-life possibilities, feedback and additional on-the-job training from more experienced workers may be essential to developing the DES. Reviewers may examine the DES's work and provide detailed feedback in the form of comments and edits. They can reject the task and send it back to the DES, who must make corrections and resubmit. This workflow allows more experienced workers to pass on their knowledge and experience. By the end of the trial period, enough data may have been collected to evaluate the worker's work quality and speed.

The server may store, within the database, crowd worker data input by a system administrator or other user. In some embodiments, each crowd worker may be stored within its own data record, in a data table storing crowd worker data, such as the example data table below.

| id | f-id | first-name | last-name |
|---|---|---|---|
| 1 | 1 | John | Doe |
| 2 | 1 | Jane | Doe |
| . . . | . . . | . . . | |

Each data record in this example data table may include: a crowd worker id data field storing a unique id associated with each crowd worker; a task framework id data field referencing a data record within the task framework data table and identifying a task framework associated with the crowd worker id; a first name data field storing the first name of the crowd worker; and a last name data field storing the last name of the crowd worker.

In the example data table above, the server may receive the crowd worker data, and automatically generate and store the data record with a crowd worker id 1, with a first name “John,” and with a last name “Doe” This example crowd worker data table also includes an additional data record subsequently received by the server.

The crowd worker being trained may examine the content created by the content extractors, compare it with the content displayed in the browser, and correct any necessary content classifications by inputting the corrections within the editable display. As noted above, FIG. 4 shows the disclosed framework as experienced by a crowd worker on a price list extraction task. Entry level crowd workers in the disclosed system, which are referred to as Data Entry Specialists (DES), correct the output of the extractors, and their work is reviewed up to two times. If automated extraction works perfectly, the crowd worker's task is simple: mark the task as being in good condition. If automated extraction fails, a crowd worker might spend up to hours manually typing all of the contents of a hard-to-extract menu. Once the DES' task is complete, the DES may submit the task, possibly by clicking a submit button, such as that seen in FIG. 4. The task may then be transmitted to the server for analysis and storage.

After decoding the transmission of the submitted task, the server may determine the total amount of content modified by the DES (e.g., number of lines changed, or percent of content changed compared to the total content). The server may then store the amount of content modified, in association with the designated task, within the database.

The server may also determine the task speed (e.g., the time it took the worker to complete the task, possibly the amount of time between the crowd worker receiving/beginning the task and submitting it to the server) and store this data associated with the task and the crowd worker in the database.

High quality is achieved through review, corrections, and recommendations of educational content to entry-level workers. Initially, the more experienced crowd worker, or another reviewer, may therefore review each task submitted by the new or less experienced crowd worker (possibly using a crowd worker UI designed to review tasks, not shown, but possibly similar to the review UI shown in FIG. 4), and may identify and correct any errors in the submitted task. The reviewer may then submit the review, again, possibly by clicking a submit button.

The server may receive the review submission and analyze the submission to determine the amount/percentage of content modified from the original task submission (or any previous review submission), as well as the task speed for the review, and store the amount/percentage of modified content and task speed in the database in association with the task. This review process may be repeated as many times as necessary to bring the tasks quality rate above a threshold determined by the request budget (described in more detail below).

As tasks are completed by each crowd worker, the server may calculate a score for each task submitted by each crowd worker, based on the quality and the speed with which the crowd worker completed the task. A key aspect of the disclosed embodiments is the ability to identify skilled workers to promote to reviewer status. In order to identify which crowd workers to promote near the top of the hierarchy (described below), a metric may be developed by which all workers are ranked, composed of two components: The first component is work quality. The quality of the task may be calculated as the inverse of the percentage of content modified in reviews of the task. Thus, if a task was reviewed, and 5% of the content was modified by the reviewer (presumably because it was incorrect), the crowd worker would have a 95% quality score for that task (possibly stored as a decimal, 0.95).

Given all of the tasks a worker has completed recently, the error score may be taken of their 75th percentile worst score. It is shown below that worker error percentiles around 80% are the most important worker-specific feature for determining the quality of a task. The server may store, within the database, crowd worker task quality score data calculated by the server. In some embodiments, each crowd worker task quality score may be stored within its own data record, in a data table storing task quality, such as the example data table below.

| id | w-id | f-id | t-id | q-score |
|---|---|---|---|---|
| 1 | 1 | 1 | 1 | .25 |
| 2 | 2 | 1 | 2 | .9 |
| 3 | 1 | 1 | 3 | .25 |
| 4 | 2 | 1 | 4 | .9 |
| 5 | 1 | 1 | 5 | .25 |
| 6 | 2 | 1 | 6 | .9 |
| . . . | . . . | . . . | . . . | . . . |

Each data record in this example data table may include: a task quality score id data field storing a unique id associated with each crowd worker task quality score; a worker id data field referencing a data record within the crowd worker data table and identifying a crowd worker associated with the crowd worker task quality score; a task framework id data field referencing a data record within the task framework data table and identifying a task framework associated with the crowd worker quality score; a task id referencing the task for which the crowd worker task quality score was calculated; and a quality score data field storing the calculated (and possibly normalized) quality score for that task.

In the example data table above, the server 110 may calculate the quality score for each received task, and automatically generate and store the data record with a quality score id 1, referencing crowd worker 1 (John Doe), framework 1 (Menu price list), task 1 (anis eggs benedict), and a quality score for task 1 of 0.25 (e.g., 75% of the content changed after review). This example crowd worker data table also includes additional data records subsequently received by the server.

The second component of the ranking metric is work speed. How long each worker takes to complete tasks on average may be measured. The server's calculation of the speed element of each crowd worker's score may be a function of selecting the task speed data for all tasks associated in the database with an identification for the task framework, and normalizing the highest task speed (e.g., the fewest number of minutes between receipt and completion of a task) to 1, and the lowest task speed (e.g., the greatest number of minutes between receipt and completion of a task) to 0. The server may then calculate each crowd worker's score relative to these normalized scores, possibly as a decimal representation of the average task speed for that crowd worker, as a percentage of the normalized fastest or slowest score.

The server may store, within the database, crowd worker speed score data calculated by the server. In some embodiments, each crowd worker speed score may be stored within its own data record, in a data table storing task speed, such as the example data table below.

| id | w-id | f-id | t-id | time | s-score |
|---|---|---|---|---|---|
| 1 | 1 | 1 | 1 | 5 | .9 |
| 2 | 2 | 1 | 2 | 5 | .9 |
| 3 | 1 | 1 | 3 | 5 | .9 |
| 4 | 2 | 1 | 4 | 5 | .9 |
| 5 | 1 | 1 | 5 | 5 | .9 |
| 6 | 2 | 1 | 6 | 5 | .9 |
| . . . | . . . | . . . | . . . | | . . . |

Each data record in this example data table may include: a speed score id data field storing a unique id associated with each crowd worker speed score; a worker id data field referencing a data record within the crowd worker data table and identifying a crowd worker associated with the crowd worker speed score; a task framework id data field referencing a data record within the task framework data table and identifying a task framework associated with the crowd worker speed score; a task id referencing the task for which the crowd worker quality score was calculated; a time data field storing the time it took to complete the task (e.g., 5 minutes); and a speed score data field storing the calculated (and possibly normalized) quality score for that task.

In the example data table above, the server may calculate the speed score for each received task, and automatically generate and store the data record with a speed score id 1, referencing crowd worker 1 (John Doe), framework 1 (Menu price list), task 1 (anis eggs benedict), and a quality score for task 1 of 0.9 (e.g., 90% of the fastest speed score, which was normalized to 1). This example crowd worker data table also includes additional data records subsequently received by the server.

This quality scoring process may be repeated for all crowd workers associated in the database with the framework defining the framework-related tasks. All workers may be sorted by their 75th percentile error score, and each worker may be assigned a score from 0 (worst) to 1 (best) based on this ranking. All workers may be ranked by how quickly they complete tasks, assigning workers a score from 0 (worst) to 1 (best) based on this ranking. Thus, in some embodiments, the range of quality scores may be normalized, so that the highest quality score is a 1, and the lowest quality score is a 0. The server may then re-calculate each crowd worker's quality score relative to these normalized scores.

A weighted average of these two metrics may be taken as a worker quality measure. The server may calculate each crowd worker's total score as a weighted average between the crowd worker's quality score and speed score. Each crowd worker's score may be re-calculated relative to all crowd workers' scores associated with that task framework each time a submitted task associated in the database with that crowd worker is reviewed. With this overall score for each worker, workers may be promoted, demoted, provided bonuses, or contracts may be ended, depending on overall task availability.

The server may store, within the database, crowd worker quality score data calculated by the server. In some embodiments, each crowd worker quality score may be stored within its own data record, in a data table storing crowd worker quality scores, such as the example data table below.

| id | w-id | f-id | q-score | s-score | t-score |
|---|---|---|---|---|---|
| 1 | 1 | 1 | .25 | .9 | .7 |
| 2 | 2 | 1 | .9 | .9 | .9 |
| . . . | . . . | . . . | . . . | . . . | . . . |

Each data record in this example data table may include: a crowd worker quality score id storing a unique id associated with the crowd worker quality score; a crowd worker id data field referencing a data record within the crowd worker data table and identifying a crowd worker associated with the crowd worker quality score id; a task framework id data field referencing a data record within the task framework data table and identifying a task framework associated with the crowd worker id; a quality score data field storing the crowd worker's normalized quality score; a speed score data field storing the crowd worker's normalized speed score; and a total score data field storing the crowd worker's normalized total score based on the weighted average between the quality score and the speed score.

In the example data table above, the server may calculate the quality, speed, and total scores for each crowd worker, and automatically generate and store the data record with a crowd worker quality score id 1, referencing crowd worker 1 (John Doe), framework 1 (Menu price list), and storing a quality score of 0.25, a speed score of 0.9, and a total score of 0.7. This example crowd worker data table also includes additional data records subsequently received by the server.

To achieve high task quality, the disclosed embodiments identify a crowd of trusted workers and organizes them in a hierarchy with the most trusted workers at the top. The server may therefore update the data records for all crowd workers, trained for tasks for a specific task framework, into a hierarchy of crowd workers by generating a total score for the crowd workers according to the method steps above, and ranking them according to their total normalized score.

The review hierarchy is depicted in FIG. 5. Workers that perform well review the output of less trusted workers. FIG. 5 shows a more detailed view of the hierarchy. Workers at the bottom level are referred to as Data Entry Specialists (DES). DES workers generally have less experience, training, and speed than the Reviewer-level workers. They are the first to see a task and do the bulk of the work. In the case of structured data extraction, a DES sees the output of automated extractors, as demonstrated in FIG. 4, and might either approve of a high-quality extraction or spend up to a few hours manually inputting or correcting the results of a failed automated extraction. Reviewers review the work of the DES, and the best Reviewers review the work of other Reviewers. As a worker's output quality improves, less of their work is reviewed. The server may therefore analyze the fixed throughput requirements and the budget for the framework defining the tasks requested by the requester, and determine, from these requirements, a distribution of needed DES, reviewers and second level reviewers.

Because per-task feedback only provides one facet of worker training and development, The disclosed embodiments may rely on a crowd Manager to develop workers more qualitatively. This Manager is manually selected from the highest quality Reviewers, and handles administrative tasks while fielding questions from other crowd workers. The Manager also looks for systemic misunderstandings that a worker has, and sends personalized emails suggesting improvements and further reading. Workers receive such a feedback email at least once per month. In reviewing workers, the Manager also recommends workers for promotion/demotion, and this feedback contributes to hierarchy changes. If the Manager spots an issue that is common to several workers, the Manager might generate a new training document to supplement workers' education. Although the crowd hierarchy is in this way self-managing, the process of on-boarding users and ending contracts is not left to the Manager: it requires manual intervention by the framework user.

As additional tasks are reviewed, and the server re-calculates the scores and ranks for the most recently reviewed tasks, the server may dynamically update the hierarchy to reassign crowd workers to new levels within the hierarchy, possibly limited by the task framework's fixed throughput and budget, discussed above. Workers are therefore incentivized to complete work quickly and at a high level of quality. A worker's speed and quality rankings are described in more detail above, but in short, workers are ranked by how poorly they performed in their middling-to-worst tasks, and by how quickly they completed tasks relative to other workers. Given this ranking, workers are automatically promoted or demoted by the server appropriately on a regular basis.

Reviewers are paid an hourly wage, while DES are paid a fixed rate based on the difficulty of their task, which can be determined after a reviewer ensures that they have done their work correctly. This payment mechanism incentivizes Reviewers to take the time they need to give workers meaningful feedback, while DES are incentivized to complete their tasks at high quality as quickly as possible. Based on typical work speed of a DES, Reviewers receive a higher hourly wage. The Manager role is also paid hourly, and earns the highest amount of all of the crowd workers. As a further incentive to do good work quickly, workers are rate-limited per week based on their quality and speed over the past 28 days. For example, the top 10% of workers are allowed to work 45 hours per week, the next 25% are allowed 35 hours, and so on, with the worst workers limited to 10 hours.

For each new completed task submitted by DES workers within the hierarchy, the server may identify the crowd worker identifier associated in the database with the crowd worker that submitted the completed task, and identify that crowd worker's quality score (i.e., the normalized inverse of the average percentage of content corrected in that worker's most recently reviewed tasks, as determined at the worker's 75% error rate).

A predictive model, referred to as TaskGrader herein, decides which tasks to review. TaskGrader leverages, from the crowd worker identified in association with the submitted completed task, available worker context, work history, and past reviews to train a regression model that predicts an error score used to decide which tasks are reviewed. The goal of the TaskGrader is to maximize quality, which are measured as the number of errors caught in a review of the crowd worker's submitted completed tasks, as reflected in the selected data records associated with the worker's previously completed tasks.

The server may predict the quality score of the submitted and completed task according to an error metric. Given two versions of task data within one or more data records of the crowd worker associated with the most recently submitted completed tasks (e.g., an initial and a reviewed version), an error metric helps the TaskGrader, described herein, to determine how much that task has changed. For textual data, this metric might be based on the number of lines changed, whereas more complex metrics are required for media such as images or video. As noted in regard to the requester described above, users can pick from the disclosed embodiments' pre-implemented error metrics or provide one of their own.

In order to generate ground truth training data for a supervised regression model, past data from the hierarchical review model may be taken advantage of. The fraction of output lines of a task that are incorrect as an error metric, as stored in the data records associated in the database with the crowd worker who submitted the most recently completed tasks, may be used. This value may be approximated by measuring the lines changed by a subsequent reviewer of a task, as stored in the data records associated in the database with the crowd worker who submitted the most recently completed tasks. Training labels may be computed by measuring the difference between the output of a tasks in these data records before and after review. Thus, tasks that have been reviewed in the hierarchy are usable as labeled examples for training the model.

An online algorithm may be used for selecting tasks to review, because new tasks continuously arrive on the system. This online algorithm frames the problem as a regression: the TaskGrader predicts the amount of error in a task, having dynamically set a review threshold at runtime in order to review tasks with the highest error without overrunning the available budget. If we assumed a static pool of tasks, the problem might better be expressed as a ranking task.

The server may then identify the budget submitted by the requester of the task framework to determine if the predicted quality score for the user falls within the range of scores determined by the budget to be in need of review. To ensure a consistent review budget (e.g., 40% of tasks should be reviewed), a threshold must be picked for the TaskGrader regression in order to spend the desired budget on review. Depending on periodic differences in worker performance and task difficulty, this threshold can change. Every few hours, the TaskGrader score distribution may be loaded for the past several thousand tasks and empirically set the TaskGrader review threshold to ensure that the threshold would have identified the desired number of tasks for review. In practice, this procedure results in accurate TaskGrader-initiated task review rates. This process may be repeated for subsequent levels of review until the predicted quality score no longer falls within the range of scores determined by the budget to be in need of review.

The space of possible implementations of TaskGrader spans three objectives: The first objective is throughput, which is the total number of tasks processed. For the design of TaskGrader, throughput is held constant and the initial processing of each task is viewed as a fixed cost. The second objective is cost, which is the amount of human effort spent by the system measured in tasks counts. this constant is held at an average of 1:56 workers per task (a parameter which should be set based on available budget and throughput requirements). The TaskGrader can allocate either 1, 2, or 3 workers per task, subject to the constraint that the average is 1:56. The third objective is quality, which is the inverse of the number of errors per task. Quality is difficult to measure in absolute terms, but can be viewed as the steady state one would reach by applying infinite number of workers per task. Quality is approximated by the number of changes (which is assumed to be errors fixed) made by each reviewer. The goal of the TaskGrader is to maximize the amount of errors fixed across all reviewed tasks.

Care should be taken with the tasks picked for future TaskGrader training. Because tasks selected for review by the TaskGrader are biased toward high error scores, they cannot be used to unbiasedly train future TaskGrader models. A fraction of the overall review budget may be reserved to randomly select tasks for review, and train future TaskGrader models on only this data. For example, if 30% of tasks are reviewed, the aim should be to have the TaskGrader select the worst 25% of tasks, and select another 5% of tasks for review randomly, only using that last 5% of tasks to train future models.

Occasionally users of the system may need to apply domain-specific tweaks to the error score. The task error score may be presented as the fraction of the output lines found incorrect in review. In its pure form, the score should lend itself reasonably well to various text-based complex work. However, one must be careful that the error score is truly representative of high or low quality. In this scenario, workers can apply comments throughout a price list's text to explain themselves without modifying the displayed price list content (e.g., \# I couldn't find a menu on this website, leaving task empty”). Reviewers sometimes changed the comments for readability, causing the comments to appear as line differences, thus affecting the error score. These comments are not relevant to the output, so workers may have been penalized for differences that were not important. For near-empty price lists, this had an especially strong effect on the error score and skewed the results. When the system was modified to remove comments prior to computing the error score, the accuracy rose by nearly 5%.

The system may then apply machine learning. For example, as noted above, machine learned classifiers identify potential menu sections, menu item names, prices, descriptions, and item choices and additions. If automated extraction works perfectly, the crowd worker's task is simple: mark the task as being in good condition. If automated extraction fails, a crowd worker might spend up to hours manually typing all of the contents of a hard-to-extract menu. The resulting crowd-structured data is used to periodically retrain classifiers to improve their accuracy. The resulting crowd-structured data is used to periodically retrain classifiers to improve their accuracy.

A structured data extraction workflow was described above. Since macrotasks power its crowd component, and because the automated extraction and classifiers do not hit good enough precision/recall levels to blindly trust the output, at least one crowd worker looks at the output of each automated extraction. In this scenario, there is still benefit to a crowd-machine hybrid: because crowd output takes the same form as the output of the automated extraction, the disclosed extraction techniques can learn from crowd relabeling. As they improve, the system requires less crowd work for high-quality results. This active learning loop applies to any data processing task with iteratively improvable output: one can train a learning algorithm on the output of a reviewed task, and use the model to classify future tasks before humans process them in order to reduce manual worker effort.

Once the initial hierarchy has been trained and assembled, growing the hierarchy or adapting it to new macrotask types is efficient. Managers streamline the development of training materials, and although new workers require time to absorb documentation and work through examples, this training time is significantly lower than the costs associated with the traditional freelance knowledge worker hiring process.

TABLE 1
Descriptions of TaskGrader Features. Each row represents one or more features. The Categorization
column places features into broad groups that will be used to evaluate feature importance.

| Feature Name or Group | Description | Categorization | |
|---|---|---|---|
| percent of input changed | how much of the task a worker changed from the input | task-specific | domain-specific |
| | they saw | | |
| grammar and spelling errors | errors such as misspellings, capitalization mistakes, and | task-specific | domain-specific |
| | missing commas | | |
| domain-specific automatic | errors detected by automatic checkers such as very high | task-specific | domain-specific |
| validation | prices, duplicate price lists, missing pricies | | |
| price list statistics | statistics on task output like # of price lists, # of | task-specific | domain-specific |
| | sections, # items per section, price list length | | |
| task times of day | time of day when different stages of the workflow are | task-specific | generalizable |
| | completed | | |
| processing time | time it took for a worker to complete the task | task-specific | generalizable |
| task urgency | high priority task must be completed within a certain | task-specific | generalizable |
| | time and can not be rejected | | |
| tasks per week | # of tasks completed per week over past few weeks | worker-specific | generalizable |
| distrubution of past task error | declies, mean, std dev, kurtosis of past error scores | worker-specific | generalizable |
| scores | | | |
| distribution of speed on past task | declies, mean, std dev, kurtosis of past processing times | worker-specific | generalizable |
| worker timezone | timezone where worker works | worker-specific | generalizable |

The TaskGrader uses a variety of data collected on workers as features for model training. Table 1 describes and categorizes the features used. These features may be categorized into two groupings:
How task-specific (e.g., how long did a task take to complete) or how worker-specific (e.g., how has the worker done on the past few tasks) is a feature? A common approach to ensuring work quality in microtask frameworks is to identify the best workers and provide them with the most work. This categorization may be used to measure how predictive of work quality the worker-specific features were.
Is a feature generalizable across task types (e.g., the time of day a worker is working) or is it domain-specific (e.g., processing a pizza menu vs. a sushi menu)? The interest is in how predictive the generalizable feature set is, because generalizable features are those that could be used in any crowd system, and would thus be of larger interest to an organization wishing to employ a TaskGrader-like model.

In this section, we evaluate the impact of the techniques proposed above on reducing error in macrotasks and investigate whether these techniques can generalize to other applications. We base our evaluations on a crowd workflow that has handled over half a million hours of human contributions, primarily for the purpose of doing large-scale structured web data extraction. We show that reviewers improve most tasks they touch, and that workers higher in the hierarchy spend less time on each task. We find that the TaskGrader focuses reviews on tasks with considerably more errors than random spot-checking. We then train the TaskGrader on varying subsets of its features and show that domain-independent (and thus generalizable) features are sufficient to significantly improve the workflow's data quality, supporting the hypothesis that such a model can add value to any macrotask crowd workflow with basic logging of worker activity. We additionally show that at constrained review budgets, combining the TaskGrader and a multilayer review hierarchy uncovers more errors than simply reviewing more tasks in single-level review. Finally, we show that a second phase of review often catches errors in a different set of tasks than the first phase.

We have developed a trained crowd of ˜300 workers, which has spiked to almost 1000 workers at various times to handle increased throughput demands. Currently, the crowd's composition is approximately 78% DES, 12% Reviewers, and 10% top-tier Reviewers. Top-tier Reviewers can review anyone's output, but typically review the work of other Reviewers to ensure full accountability. The Manager sends 5-10 emails a day to workers with specific issues in their work, such as spelling/syntax errors or incorrect content. He also responds to 10-20 emails a day from workers with various questions and comments.

The throughput of the system varies drastically in response to business objectives. The 90th percentile week saw 19 k tasks completed, and the 99th percentile week saw 33 k tasks completed, not all of which were structured data extraction tasks. Tasks are generally completed within a few hours, and 75% of all tasks are completed within 24 hours.

We evaluate our techniques on an industry deployment of Argonaut, in the context of the complex price list structuring task described above. The crowd forming the hierarchy is also described above. The training data consisted of a subset of approximately 60 k price list-structuring tasks that had been spot-checked by Reviewers over a fixed period. Most tasks corresponded to a business, and the worker is expected to extract all of the price lists for that business. The task error score distribution is heavily skewed toward 0: 62% of tasks have an error score less than 0.025. If the TaskGrader could predict these scores, we could decrease review budgets without affecting output quality. 27% of the tasks contain no price lists and result in empty output. This happens if, for example, the task links to a website that does not exist, or doesn't contain any price lists. For these tasks, the error score is usually either 0 or 1, meaning the worker correctly identified that the task is empty, or they did not.

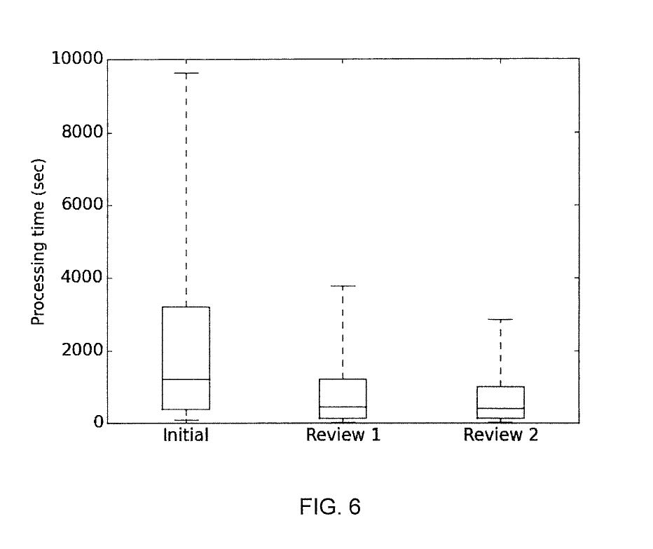

FIG. 6 shows the amount of time workers spend at various stages of task completion. The initial phase of work might require significant data entry if automated extraction fails, and varies depending on the length of the website being extracted. This phase generally takes less than an hour, but can take up to three hours in the worst case. Subsequent review phases take less time, with both phases generally taking less than an hour each. Review 1 tasks generally take longer than Review 2 tasks, likely because: 1) we promote workers that produce high quality work quickly, and so Review 2 workers tend to be faster, and 2) if Review 1 catches errors, Review 2 might require less work.

We evaluate the effectiveness of review in several ways, starting with expert coding. Two authors looked at a random sample of 50 tasks each that had changed by more than 5% in their first review. The authors were presented with the pre-review and post-review output in a randomized order so that they could not tell which was which. For each task, the authors identified which version of the task, if any, was of higher quality. The two sets of 50 tasks overlapped by 25 each, so that we could measure agreement rates between authors, and resulted in 75 unique tasks for evaluation.

For the 25 tasks on which authors overlapped, two were discarded because the website was no longer accessible. Of the remaining 23 tasks, authors agreed on 21 of them, with one author marking the remaining 2 as indistinguishable in quality. Given that authors agreed on all of the tasks on which they were certain, we find that expert task quality coding can be a high-agreement activity.

TABLE 2
Of the 71 valid tasks two authors coded,
9.9% decreased in quality after review, 18.3% had no
discernible change, and 71.8% improved in quality.

| Metric Name | Count | Percentage |
|---|---|---|
| Total tasks | 75 | — |
| Discarded tasks | 4 | — |
| Valid tasks | 71 | 100% |
| Decreased quality | 7 | 9.9% |
| No discernible change | 13 | 18.3% |
| Improved quality | 51 | 71.8% |

Table 2 summarizes the results of this expert coding experiment. Of 75 tasks, 4 were discarded for technical reasons (e.g., website down). Of the remaining 71, the authors found 13 to not be discernibly different in either version. On 51 of the tasks, the authors agreed that the reviewed version was higher-quality (though they were blind to which task had been reviewed when making their choice). This suggests that, on our data thresholded by ≧5% of lines changed, we found that review decreases quality 9.9% of the time, does not discernibly change quality 18.3% of the time, and improves quality 71.8% of the time. These findings point toward the key benefit of the hierarchy: when a single review phase causes a measurable change in a task, it improves output with high probability.

Since task quality varies, it is important for the TaskGrader to identify the lowest-quality tasks for review. We trained the TaskGrader, a gradient boosting regression model, on 90% of the data as a training set, holding out 10% as a test set. We compared gradient boosting regression to several models, including support vector machines, linear regression, and random forests, and used cross-validation on the training set to identify the best model type. We also used the training set to perform a grid search to set hyperparameters for our models.

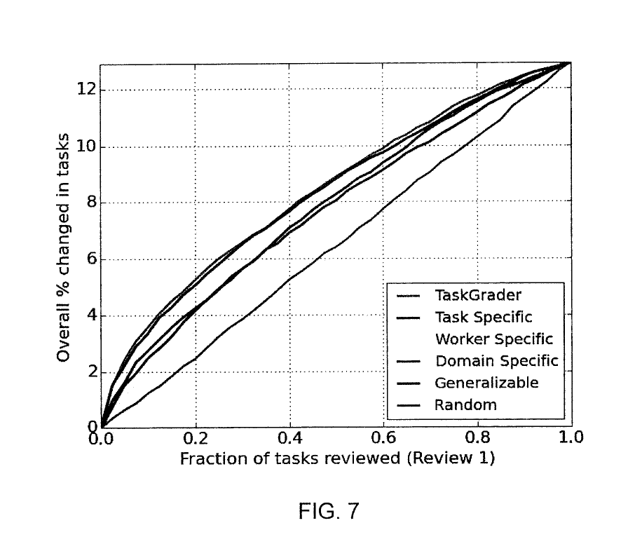

We evaluate the TaskGrader by the aggregate errors it helps us catch at different review budgets. To capture this notion, we compute the errors caught (represented by the percentage of lines changed in review) by reviewing the tasks identified by the TaskGrader. We compare these to the errors caught by reviewing a random sample of N percent of tasks. FIG. 7 shows the errors caught as a function of fraction of tasks reviewed for the TaskGrader model trained on various feature subsets, as well as a baseline random review strategy. We find that at all review budgets less than the trivial 100% case (wherein the TaskGrader is identical to random review), the TaskGrader is able to identify significantly more error than the random spot check strategy.

We now simultaneously explore which features are most predictive of task error and whether the model might generalize to other problem areas. As previously discussed, we broke the features used to train the TaskGrader into two groupings: task-specific vs worker-specific, and generalizable vs. domain-specific. We now study how these groupings affect model performance.

FIG. 7 shows the performance of the TaskGrader model trained only on features from particular feature groupings. Each feature grouping performs better than random sampling, suggesting they provide some signal.

Generalizable features perform comparably to domain-specific ones. Because features unrelated to structured data extraction are still predictive of task error, it is likely that the TaskGrader model can be implemented easily in other macrotask scenarios without losing significant predictive power.

For our application, it is also interesting to note that task-specific features, such as work time and percent of input changed, outperform worker-specific features, such as mean error on past tasks. This finding is counter to the conventional wisdom on microtasks, where the primary approaches to quality control rely on identifying and compensating for poorly-performing workers. There could be several reasons for this difference: 1) over time, our incentive systems have biased poorly performing workers away from the platform, dampening the signal of individual worker performance, and 2) there is high variability in macrotask difficulty, so worker-specific features do not capture these effects as well as task-specific ones.

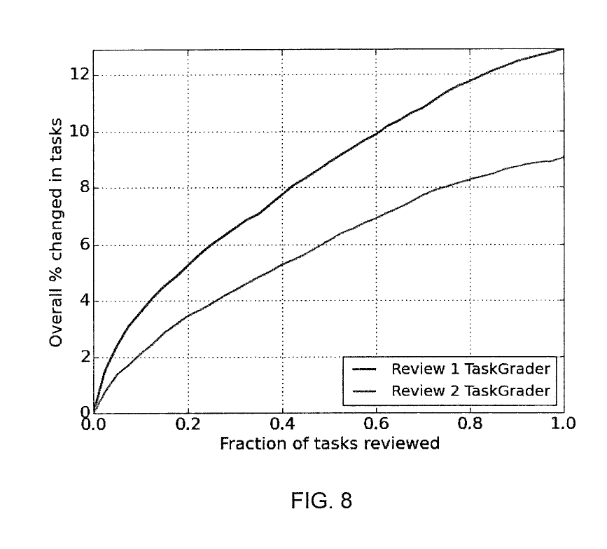

The TaskGrader is applied at each level of the hierarchy to determine if the task should be sent to the next level. FIG. 8 shows the error caught by using the TaskGrader to send tasks for a first and second review. The maximum percent changed (at 1.0 on the x-axis) is smaller in Review 2 than in Review 1, which suggests that tasks are higher quality on average by their second review, therefore requiring fewer improvements.

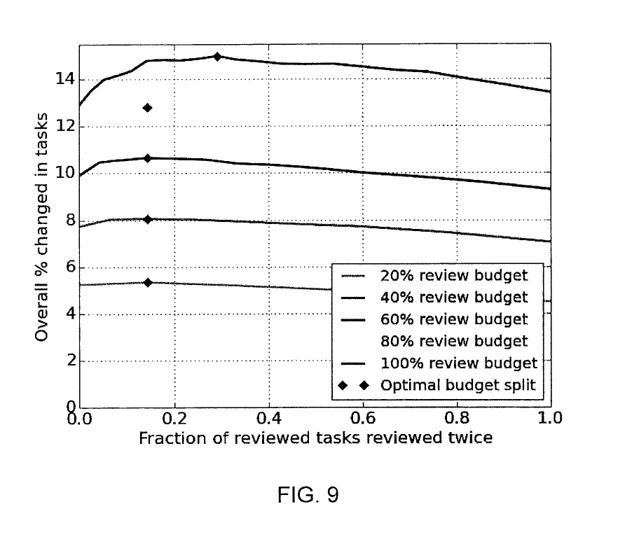

We also examined how the amount of error caught would change if we split our budget between Review 1 and Review 2, using the TaskGrader to help us judge if we should review a new task (Review 1), or review a previously reviewed task (Review 2). This approach might catch more errors by reviewing the worst tasks multiple times and not reviewing the best tasks at all. FIG. 9 shows the total error caught for a fixed total budget as we vary the split between Review 1 and Review 2. The budget values shown in the legend are the number of tasks that get reviews as a percentage of the total number of tasks in the system. The x-axis ranges from 0% Review 2 (100% Review 1) to 100% Review 2. Since a task can not see Review 2 without first seeing Review 1, 100% Review 2 means the budget is split evenly between Review 1 and Review 2. For example, if the budget is an average of 0.4 reviews per task, at the 100% Review 2 data point, 20% of tasks are selected for both Review 1 and Review 2.

TABLE 3
Improvement over random spot-checks
with optimal Review 1 and Review 2 splits at
different budgets.

| | Review Budget | | | | |
|---|---|---|---|---|---|
| | 20% | 40% | 60% | 80% | 100% |
| Optimal % reviewed twice | 14.3 | 14.3 | 14.3 | 14.3 | 29.0 |
| % improvement over random | 118 | 53.6 | 35.3 | 21.4 | 16.2 |

Examining the figure, we see that for a given budget, there is an optimal trade-off between level 1 and level 2 review. Table 3 shows the optimal percent of tasks to review twice along with the improvement over random review at each budget. As the review budget decreases, the benefit of TaskGrader-suggested reviews become more pronounced, yielding a full 118% improvement over random at a 20% budget. It is also worth noting that with a random selection strategy, there is no benefit to second-level review: on average, randomly selecting tasks for a second review will catch fewer errors than simply reviewing a new task for the first time (as suggested by FIG. 8).

Next we examine in more detail what is being changed by the two phases of review. We measure if reviewers are editing the same tasks and also how correlated the magnitude of the Review 1 and Review 2 changes are.

In order to measure the overlap between the most changed tasks in the two phases of review, we start with a set of 39,180 tasks that were reviewed twice. If we look at the 20% (approx. 7840) most changed tasks in Review 1 and the 20% most changed tasks in Review 2, the two sets of tasks overlap by around 25% (approx. 1960). We leave out the full results due to space restrictions, but this trend continues in that the most changed tasks in each phase of review do not meaningfully overlap until we look at the 75% most changed tasks in each phase. This suggests that Review 2 errors are mostly caught in tasks that were not heavily corrected in Review 1.

As another measure of the relationship between Review 1 and Review 2, we measure the correlation between the percentage of changes to a task in each review phase. The Pearson's correlation, which ranges from −1 (completely inverted correlation) to 1 (completely positive correlation), with 0 representing no correlation, was 0.096. To avoid making distribution assumptions about our data, we also measured the nonparametric Spearman's rank correlation and found it to be 0.176. Both effects were significant with a two-tailed p-value of p<:0001. In both cases, we find a very weak positive correlation between the two phases of review, which suggests that while Review 1 and Review 2 might correct some of the same errors, they largely catch errors on different tasks.

These findings support the hierarchical review model in an unintuitive way. Because we know review generally improves tasks, it is interesting to see two serial review phases catching errors on different tasks. This suggests some natural and exciting follow-on work. First, because Review 2 reviewers are generally higher-ranked, are they simply more adept at catching more challenging errors? Second, are the classes of errors that are caught in the two phases of review fundamentally different in some way? Finally, can the overlap be explained by a phenomenon such as “falling asleep at the wheel,” where reviewer attention decreases over the course of a sitting, and subsequent review phases simply provide more eyes and attention? Studying deeper review hierarchies and classifying error types will be interesting future work to help answer these questions.

Our results show that in crowd workflows built around macrotasks, a worker hierarchy, predictive modeling to allocate reviewing resources, and a model of worker performance can effectively reduce error in task output. As the budget available to spend on task review decreases, these techniques are both more important and more effective, combining to provide up to 118% improvement in errors caught over random spotchecking. While our features included a mix of domain-specific and generalizable features, using only the generalizable features resulted in a model that still had significant predictive power, suggesting that the Argonaut hierarchy and TaskGrader model can easily be trained in other macrotask settings without much task-specific featurization. The approaches that we present in this paper are used at scale in industry, where our production implementation significantly improves data quality in a crowd work system that has handled millions of tasks and utilized over half a million hours of worker participation.

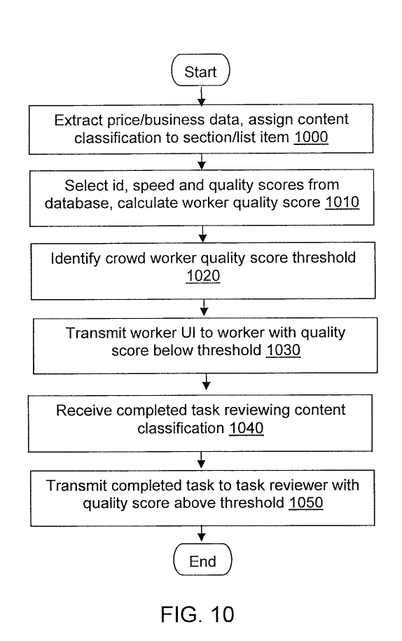

Turning now to FIG. 10, and in summary of the disclosed embodiments, a flowchart is shown, demonstrating one of the disclosed embodiments. In this flowchart, the server executes an automated data extraction identifying a price list or a business listing within the content of a website, and automatically assigns a content classification to each section or list item in the price list or the business listing (Step 1000). The server then selects, from the database, a plurality of task data records, each task data record in the plurality of task data records storing: a crowd worker identifier for a crowd worker that completed a task; a task speed score comprising a number of minutes between the crowd worker beginning and completing the task; and a task quality score comprising a percentage of content in the task not modified by a review crowd worker that reviewed the task, and calculate, for each crowd worker: a task speed average score, by averaging the task speed score for all data records storing the crowd worker identifier; a task quality average score, by averaging the task quality data score within all data records storing the crowd worker identifier; and a crowd worker quality score comprising a weighted average of the task speed average score and the quality average score (Step 1010). The server then identifies, within the database or the instructions, a crowd worker quality score threshold (Step 1020). The server then renders a crowd worker user interface comprising: the price list or the business listing; and an editable display of the content classification automatically assigned to each section or list item, and transmits the crowd worker user interface to a client computer operated by a data entry specialist comprising a crowd worker identifier with a crowd worker quality score below the crowd worker quality score threshold (Step 1030). The server then receives, from the crowd worker user interface, a completed task comprising a review of the content classification by the data entry specialist (Step 1040), and transmits the completed task to a client computer operated by a task reviewer comprising a crowd worker identifier with a crowd worker quality score above the crowd worker quality score threshold.

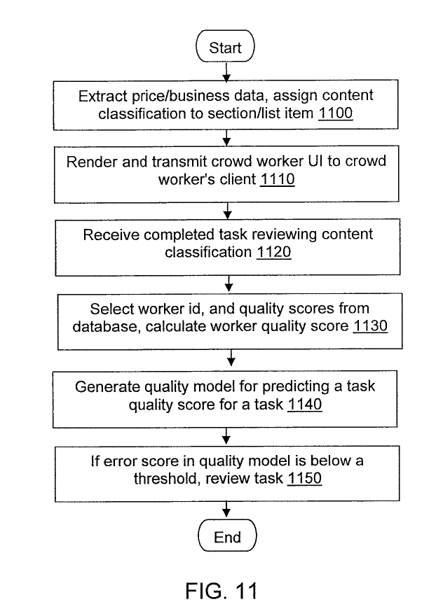

Turning now to FIG. 11, a flowchart is shown, demonstrating one of the disclosed embodiments. In this flowchart, the server executes an automated data extraction identifying a price list or a business listing within the content of a website, and automatically assign a content classification to each section or list item in the price list or the business listing (Step 1100). The server then renders a crowd worker user interface comprising: the price list or the business listing; and an editable display of the content classification automatically assigned to each section or list item, and transmits the crowd worker user interface to a client computer operated by a crowd worker (Step 1110). The server then receives, from the crowd worker user interface, a completed task comprising a review of the content classification by the crowd worker (Step 1120). The server then selects, from a database coupled to the network, a plurality of task data records associated in the database with the crowd worker, each task data record in the plurality of task data records storing: a crowd worker identifier for the crowd worker that completed the task; and a task quality score comprising a percentage of content in the task not modified by a review crowd worker that reviewed the task; and calculate a crowd worker quality score for the crowd worker by: averaging the task quality score stored in the plurality of task data records; and identifying an error score at a predetermined percentile of the averaged task quality score (Step 1130). The server then generates a quality model for predicting a task quality score for the task, according to the error score (Step 1140). Responsive to a determination that a the error score in the quality model is below a predetermined threshold, transmit the task to a client computer operated by at least one task reviewer for review (Step 1150).

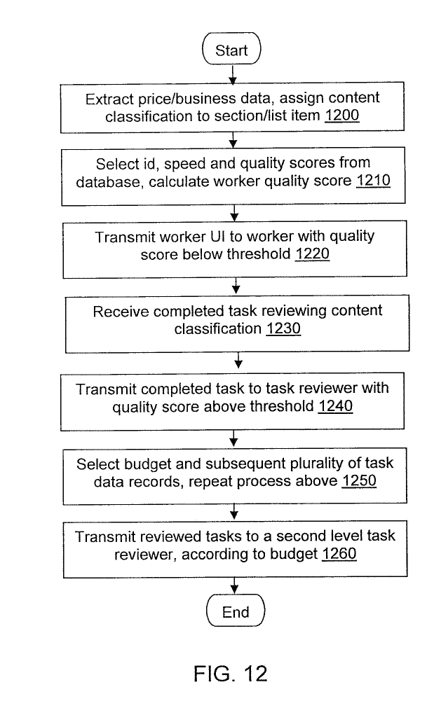

Turning now to FIG. 12, a flowchart is shown, demonstrating one of the disclosed embodiments. In this flowchart, the server executes an automated data extraction identifying a price list or a business listing within the content of a website, and automatically assigns a content classification to each section or list item in the price list or the business listing (Step 1200). The server then selects, from a database coupled to the network, a first plurality of task data records, each task data record in the plurality of task data records storing: a crowd worker identifier for a crowd worker that completed a task; a task speed score comprising a number of minutes between the crowd worker beginning and completing the task; a task quality score comprising a percentage of content in the task not modified by a review crowd worker that reviewed the task; and calculates a first crowd worker quality score associated with each crowd worker identifier, and comprising a weighted average of a task speed average score and a quality average score (Step 1210). The server then renders a crowd worker user interface comprising: the price list or the business listing; and an editable display of the content classification automatically assigned to each section or list item, and transmits the crowd worker user interface to a client computer operated by a data entry specialist comprising a crowd worker identifier with a crowd worker quality score below the crowd worker quality score threshold (Step 1220). The server then receives, from the crowd worker user interface, a completed task comprising a review of the content classification by the data entry specialist (Step 1230). The server then transmits the completed task to a client computer operated by a task reviewer comprising a crowd worker identifier with a crowd worker quality score above the crowd worker quality score threshold (Step 1240); The server then selects, from the database: a data record defining a budget for a task framework, and a second plurality of task data records stored subsequent to the first plurality of task data records. The server then calculates a second crowd worker quality score, associated with each crowd worker identifier, from the second plurality of task data records (Step 1250). The server then transmits each of a plurality of reviewed tasks to a client computer operated by a second level task reviewer, comprising a crowd worker identifier with a crowd worker quality score above the crowd worker quality score threshold, according to a threshold number of reviewed tasks to be transmitted to the second level task reviewer, based on the budget for the task framework (Step 1260).

The invention claimed is:

1. A system, comprising at least one processor executing instructions within a memory coupled to a server computer coupled to a network, the instructions causing the server computer to:
execute an automated data extraction identifying a price list or a business listing within the content of a website;
automatically assign a content classification to each section or list item in the price list or the business listing;
select, from a database coupled to the network, a first plurality of task data records, each task data record in the plurality of task data records storing:
a crowd worker identifier for a crowd worker that completed a task;
a task speed score comprising a number of minutes between the crowd worker beginning and completing the task;
a task quality score comprising a percentage of content in the task not modified by a review crowd worker that reviewed the task;
calculate a first crowd worker quality score associated with each crowd worker identifier, and comprising a weighted average of a task speed average score and a quality average score;
render a crowd worker user interface comprising:
the price list or the business listing; and
an editable display of the content classification automatically assigned to each section or list item;
transmit the crowd worker user interface to a client computer operated by a data entry specialist comprising a crowd worker identifier with a crowd worker quality score below the crowd worker quality score threshold;
receive, from the crowd worker user interface, a completed task comprising a review of the content classification by the data entry specialist;
transmit the completed task to a client computer operated by a task reviewer comprising a crowd worker identifier with a crowd worker quality score above the crowd worker quality score threshold
select, from the database:
a data record defining a budget for a task framework; and
a second plurality of task data records stored subsequent to the first plurality of task data records;
calculate a second crowd worker quality score, associated with each crowd worker identifier, from the second plurality of task data records;
transmit each of a plurality of reviewed tasks to a client computer operated by a second level task reviewer, comprising a crowd worker identifier with a crowd worker quality score above the crowd worker quality score threshold, according to a threshold number of reviewed tasks to be transmitted to the second level task reviewer, based on the budget for the task framework.

2. The system of claim 1, wherein a task requester defines the automated data extraction and the content classification within a task framework comprising:
a schema defining the section, a key-value mapping, or the list items within the price list or the business listing; and
at least one user interface control to be rendered within the crowd worker user interface; and
at least one customized error metric used to determine the task quality score.

3. The system of claim 2, wherein the customized error metric comprises:
a fraction of output text lines from the automated data extraction of the section or list item that are incorrect before and after review; or
a fraction of output data from the automated data extraction of at least one image or video in the section or list item that are incorrect before and after review.

4. The system of claim 2, wherein the customized error metric is determined by an inverse number of errors for the task.

5. The system of claim 1, wherein the price list is a restaurant menu

6. The system of claim 5, wherein the section or list item comprises a menu section, a menu item name, a menu item price, a menu item description, or a menu item addition.

7. The system of claim 1, wherein the budget determines a percentage of tasks to be reviewed.

8. The system of claim 7, wherein the percentage is 40%.

9. The system of claim 1, wherein the server dynamically generates a data record for each crowd worker in a plurality of workers, storing a position within a crowd hierarchy.

10. A method, comprising the steps of:
executing, by a server computer coupled to a network and comprising at least one processor executing instructions within a memory, an automated data extraction identifying a price list or a business listing within the content of a website;
automatically assigning, by the server computer, a content classification to each section or list item in the price list or the business listing;
selecting, by the server computer, from a database coupled to the network, a first plurality of task data records, each task data record in the plurality of task data records storing:
a crowd worker identifier for a crowd worker that completed a task;
a task speed score comprising a number of minutes between the crowd worker beginning and completing the task;
a task quality score comprising a percentage of content in the task not modified by a review crowd worker that reviewed the task;
calculating, by the server computer, a first crowd worker quality score associated with each crowd worker identifier, and comprising a weighted average of a task speed average score and a quality average score;
rendering, by the server computer, a crowd worker user interface comprising:
the price list or the business listing; and
an editable display of the content classification automatically assigned to each section or list item;
transmitting, by the server computer, the crowd worker user interface to a client computer operated by a data entry specialist comprising a crowd worker identifier with a crowd worker quality score below the crowd worker quality score threshold;
receiving, by the server computer, from the crowd worker user interface, a completed task comprising a review of the content classification by the data entry specialist;
transmitting, by the server computer, the completed task to a client computer operated by a task reviewer comprising a crowd worker identifier with a crowd worker quality score above the crowd worker quality score threshold
selecting, by the server computer, from the database:
a data record defining a budget for a task framework; and
a second plurality of task data records stored subsequent to the first plurality of task data records;
calculating, by the server computer, a second crowd worker quality score, associated with each crowd worker identifier, from the second plurality of task data records;
transmitting, by the server computer, each of a plurality of reviewed tasks to a client computer operated by a second level task reviewer, comprising a crowd worker identifier with a crowd worker quality score above the crowd worker quality score threshold, according to a threshold number of reviewed tasks to be transmitted to the second level task reviewer, based on the budget for the task framework.

11. The method of claim 10, wherein a task requester defines the automated data extraction and the content classification within a task framework comprising:
a schema defining the section, a key-value mapping, or the list items within the price list or the business listing; and
at least one user interface control to be rendered within the crowd worker user interface; and
at least one customized error metric used to determine the task quality score.

12. The method of claim 11, wherein the customized error metric comprises:
a fraction of output text lines from the automated data extraction of the section or list item that are incorrect before and after review; or
a fraction of output data from the automated data extraction of at least one image or video in the section or list item that are incorrect before and after review.

13. The method of claim 11, wherein the customized error metric is determined by an inverse number of errors for the task.

14. The method of claim 10, wherein the price list is a restaurant menu

15. The method of claim 14, wherein the section or list item comprises a menu section, a menu item name, a menu item price, a menu item description, or a menu item addition.

16. The method of claim 10, wherein the budget determines a percentage of tasks to be reviewed.

17. The method of claim 16, wherein the percentage is 40%.

18. The method of claim 10, wherein the server dynamically generates a data record for each crowd worker in a plurality of workers, storing a position within a crowd hierarchy.
